(19) United States
(12) Patent Application Publication
(10) Pub. No.: US 2008/0067283 A1
(43) Pub. Date: Mar. 20, 2008

(54) METHODS AND APPARATUS FOR REDUCING NOISE VIA A PLASMA FAIRING

(75) Inventor: Flint O. Thomas, Granger, IN (US)

Correspondence Address: HANLEY, FLIGHT & ZIMMERMAN, LLC, 150 S. WACKER DRIVE, SUITE 2100, CHICAGO, IL, 60606, US

(73) Assignee: University of Notre Dame du Lac, Notre Dame, IN (US)

(21) Appl. No.: 11/686,153

(22) Filed: Mar. 14, 2007

Related U.S. Application Data
(60) Provisional application No. 60/782,137, filed on Mar. 14, 2006.

(51) Int. Cl. B64C 21/00; B64C 1/40

(52) U.S. Cl. 244/1 N; 244/130

(57) ABSTRACT

A plasma fairing for reducing noise generated by, for example, an aircraft landing gear is disclosed. The plasma fairing includes at least one plasma generating device, such as a single dielectric barrier discharge plasma actuator, coupled to a body, such as an aircraft landing gear, and a power supply electrically coupled to the plasma generating device. When energized, the plasma generating device generates a plasma within a fluid flow and reduces body flow separation of the fluid flow over the surface of the body. In another example, the body includes a plurality of plasma generating devices mounted to the surface the body to further aid in noise reduction.

### CROSS REFERENCE TO RELATED APPLICATION

This application is a non-provisional application claiming priority from U.S. Provisional Application Ser. No. 60/782,137, filed Mar. 14, 2006, entitled “Plasma Fairing for landing gear noise reduction” and incorporated herein by reference in its entirety.

### GOVERNMENT INTEREST STATEMENT

This disclosure was made, in part, with United States government support from the National Aeronautics and Space Administration, Contract No. NAG1-03076. The United States government has certain rights in this invention.

### FIELD OF THE DISCLOSURE

The present disclosure relates generally to noise reduction and more particularly to methods and apparatus for reducing noise via a plasma fairing.

### BACKGROUND OF RELATED ART

A primary component of airframe noise on both takeoff and landing approach is due to the landing gear. In particular, the jet noise component of overall aircraft noise has been significantly reduced by, for example, utilization of engines with high bypass ratios. Accordingly, in landing approaches, when engines are throttled down, airframe noise now represents a primary noise source. Two key sources of airframe noise include landing gear noise associated with flow past landing gear struts, uncovered wheel wells, and undercarriage elements, as well as high-lift system noise associated with trailing flaps, leading edge slats and the associated brackets and rigging.

Although the detailed physical mechanisms of noise production from these sources may differ and are still a focus of ongoing investigations, it is clear that a common feature of each is a region of unsteady, separated flow. Free shear layers that result from flow separation are inviscidly unstable. Consequently, the flow is locally dominated by large-scale, unsteady vorticity that arises as a natural outcome of the rapidly growing instabilities. Consequently, the flow is locally dominated by large-scale, unsteady vorticity that arises as a natural outcome of these rapidly growing instabilities. The resulting unsteady vertical field plays an important role as an aeroacoustic source.

A few common examples include flow separation over landing gear elements, the separated shear layers that form on the partial-span trailing flap side edge, the shear layer that bounds the separated leading edge slat cove flow and the separated flow that forms the unsteady slat wake. Each of these separated flows has been shown to give rise, in their own way to airframe noise production. Hence, any flow control strategy, either active or passive, that eliminates or minimizes such flow separation will likely have a significant effect on reducing airframe noise.

Therefore, separation control is oftentimes at the core of many noise control strategies currently under investigation for commercial transport aircraft. For example, in one instance, passive flow control in the form of physical fairings are designed to reduce flow separation over landing gear elements. However, passive fairings are limited by practical considerations including the need to allow easy access for gear maintenance and the ability to stow the gear in cruise. Certainly, the added weight of a passive fairing is also a consideration.

In another example, an active flow control system may take the form of a blowing or suction system. In these instances, the systems must deal with the increased part count and maintenance costs associated with complex bleed air ducting systems. Furthermore, it is oftentimes quite expensive to retrofit such active flow control systems to existing commercial transport aircraft.

Flyover tests have shown that landing gear noise represents a primary source of airframe noise. The inherent bluff body characteristics of landing gear give rise to large-scale flow separation that results in noise production through unsteady wake flow and large-scale vortex instability and deformation. Large-scale, unsteady Reynolds-averaged Navier-Stokes simulations of the flow field over a landing gear assembly have been performed and these simulations capture the unsteady vortex shedding that occurs from the oloe and struts, as well as from the landing gear box and rear wheels. This study also serves to demonstrate the extreme complexity of the unsteady flow over the gear. A full aeroacoustic analysis of a landing gear assembly from an unsteady Reynolds Averaged Navier-Stokes simulation of the flow over a landing gear assembly was used as input to the Ffowcs Williams-Hawking equation in order to predict the noise at far-field observer locations. These computations demonstrate the potential of large scale numerical simulations in the identification of acoustic sources in complex landing gear geometries.

### BRIEF DESCRIPTION OF THE DRAWINGS

FIG. 1 is a schematic illustration of an example single dielectric barrier discharge plasma actuator for use as a plasma fairing.

FIG. 2 is a side elevational view of an example landing gear strut for use with the single dielectric barrier discharge plasma actuator of FIG. 1

FIG. 3 is a cross-sectional view of the example landing gear strut of FIG. 2, taken along line 3-3, showing the landing gear having a plurality of surface mounted single dielectric barrier discharge plasma actuators thereon, and being subjected to a fluid flow without energizing the single dielectric barrier discharge plasma actuators.

FIG. 4 is a cross-sectional view similar to FIG. 3, but showing the landing gear being subjected to a fluid flow with energizing the single dielectric barrier discharge plasma actuators.

FIG. 5 is a schematic illustration showing the detail of the landing gear being subjected to a fluid flow with energizing of the single dielectric barrier discharge plasma actuators.

FIG. 6 is a cross-sectional schematic of an example plasma fairing having two single dielectric barrier discharge plasma actuators mounted on the surface of a cylinder.

FIG. 6B is an example illustration of a steady actuation signal and an unsteady actuation signal.

FIG. 7 is schematic of an example actuator circuit for energizing the single dielectric barrier discharge plasma actuator of FIG. 1.

FIG. 8 is a particle image velocimetry image of the example plasma fairing of FIG. 6, showing the energizing of one of the two single dielectric barrier discharge plasma actuators without a fluid flow.

FIG. 9 is a particle image velocimetry image similar to FIG. 8, but showing both of the single dielectric barrier discharge plasma actuators being energized.

FIG. 10 is a smoke flow visualization of the plasma fairing of FIG. 6 showing the energizing of both of the two single dielectric barrier discharge plasma actuators and in the presence of a fluid flow with a Reynolds number of 15,000.

FIG. 11 is a graph comparing the wake mean velocity profiles with and without energizing of the two single dielectric barrier discharge plasma actuators.

FIG. 12 is a graph comparing the drag coefficient of the plasma fairing of FIG. 6 with and without energizing the two single dielectric barrier discharge plasma actuators.

FIG. 13 is graph comparing the streamwise variation in the wake maximum velocity defect with and without energizing of the two single dielectric barrier discharge plasma actuators.

FIG. 14 is a graph comparing the velocity spectra for a Reynolds numbers of 12,800 and obtained with and without the energizing of the two single dielectric barrier discharge plasma actuators.

FIG. 15 is a graph comparing the velocity autospectra for different Reynolds numbers obtained at a fixed position and with the energizing of the two single dielectric barrier discharge plasma actuators.

FIG. 16 is a plasma fairing similar to FIG. 6, but showing a single dielectric barrier discharge plasma actuators disposed on a splitter plate.

FIG. 17 is a particle image velocimetry image of the example plasma fairing of FIG. 16, showing the energizing of the single dielectric barrier discharge plasma actuators without a fluid flow.

FIG. 18 is smoke flow visualization of the plasma fairing of FIG. 6 showing the energizing of one of the two single dielectric barrier discharge plasma actuators.

### DETAILED DESCRIPTION

The following description of the disclosed embodiment is not intended to limit the scope of the invention to the precise form or forms detailed herein. Instead the following description is intended to be illustrative of the principles of the invention so that others may follow its teachings.

As described above, it has been suggested from preliminary experiments performed at NASA Ames Research Center and in Europe that faired landing gear generates considerably less noise than corresponding unmodified gear. However, the need to access the gear for maintenance and stow the gear in cruise limits the utility of passive separation control via fairings. In the present disclosure, surface mounted single dielectric barrier discharge plasma actuators are used to create a “plasma fairing” that effectively streamlines the gear by active means. In particular, the SDBD plasma actuators reduce bluff body flow separation that give rise to associated landing gear noise.

It will be appreciated by one of ordinary skill in the art that while the disclosed examples are directed to a plasma fairing for a landing gear structure, the disclosed plasma fairing may be utilized in a variety of application environments. For example, the plasma fairing may be utilized to provide active aerodynamic separation control to any suitable body, including, but not limited to, airframe components such as the fuselage, wings, wheels, undercarriage, flaps, rotors, propellers, etc., and/or any other application such as, low pressure turbine blades, lift augmentation of airfoils, wing leading edge separation control, active shock wave control for supersonic aircraft inlets, etc.

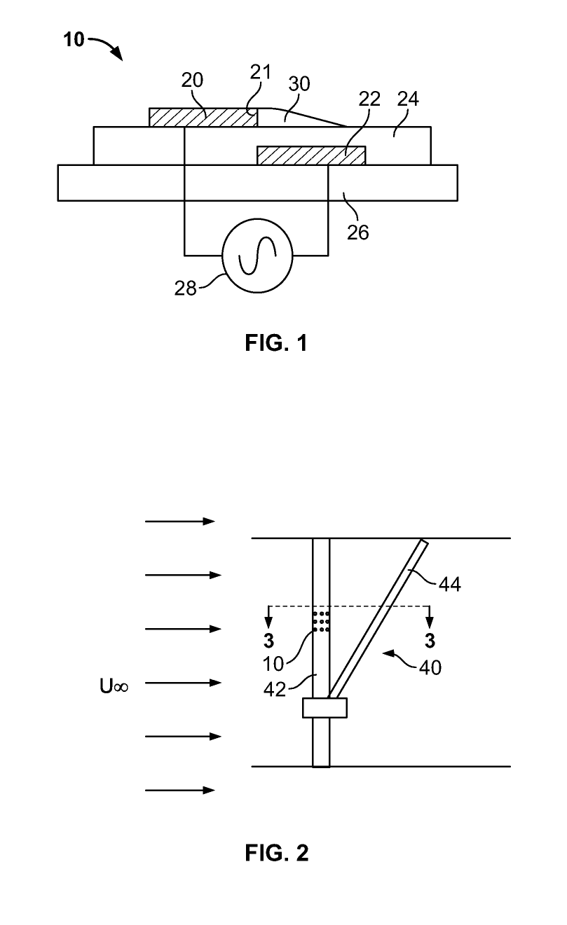

Referring now to FIG. 1, an example of a single dielectric barrier discharge (SDBD) plasma actuator 10 is shown. As shown in FIG. 1, a plasma actuator 10 includes an exposed electrode 20 and an enclosed electrode 22 separated by a dielectric barrier material 24. The electrodes 20, 24 and the dielectric material 24 may be mounted, for example, to a substrate 26. A high voltage AC power supply 28 is electrically coupled to the electrodes 20, 22. It will be understood that the exposed electrode 20 may be at least partially covered, while the enclosed electrode may be at least partially exposed. During operation, when the amplitude of the applied AC voltage is large enough, the air will locally ionize in the region of the largest electric field (i.e. potential gradient) forming a plasma 30. The plasma 30 generally forms at an edge 21 of the exposed electrode 20 and is accompanied by a coupling of directed momentum to the surrounding air. For example, the formation of the plasma 30 introduces steady or unsteady velocity components in the surrounding air that form the basis of the disclosed flow control strategies as will be described below.

The induced velocity by the plasma 30 can be tailored through the design of the arrangement of the electrodes 20, 22, which controls the spatial electric field. For example, various arrangements of the electrodes 20, 22 can produce wall jets, spanwise vortices or streamwise vortices, when placed on the wall in a boundary layer. The ability to tailor the actuator-induced flow by the arrangement of the electrodes 20, 22 relative to each other and to the flow direction allows one to achieve a wide variety of actuation strategies for airframe noise control.

To maintain the plasma 30, in this example an applied AC voltage from the power supply 28 is required. In the illustrated example, the plasma 30 can sustain a large volume discharge at atmospheric pressure without arcing because it is self-limiting. In particular, during the half-cycle for which the exposed electrode 20 is more negative than the surface of the dielectric 24 and the covered electrode 22, and assuming a sufficiently large potential difference, electrons are emitted from the exposed electrode 20 and terminate on the surface of the dielectric 24. The buildup of surface charge on the dielectric 24 opposes the applied voltage and gives the plasma 30 discharge its self-limiting character. That is, the plasma 30 is extinguished unless the magnitude of the applied voltage continuously increases. On the next half-cycle, the charge available for discharge is limited to that deposited on the dielectric surface during the previous half-cycle and the plasma 30 again forms as it returns to the exposed electrode 20.

As described above, although a faired landing gear can generate less noise than the corresponding unmodified gear, the need to access the gear for maintenance and stow the gear in cruise makes passive separation control via fairings impractical. In the present disclosure, surface mounted SDBD plasma actuators 10 are used to create a plasma fairing 60 that effectively streamlines the gear by active means.

Referring now to FIG. 2, an example landing gear 40 is shown. The landing gear 40 includes an upstream strut 42 and a downstream strut 44. As will be apparent to one of ordinary skill in the art, many of the components that form the landing gear 40 take the form of bluff bodies in cross-flow. The use of surface mounted SDBD plasma actuators 10, reduce bluff body flow separation that gives rise to landing gear noise. This effective streamlining of the landing gear element by the plasma actuators we term a “plasma fairing.”

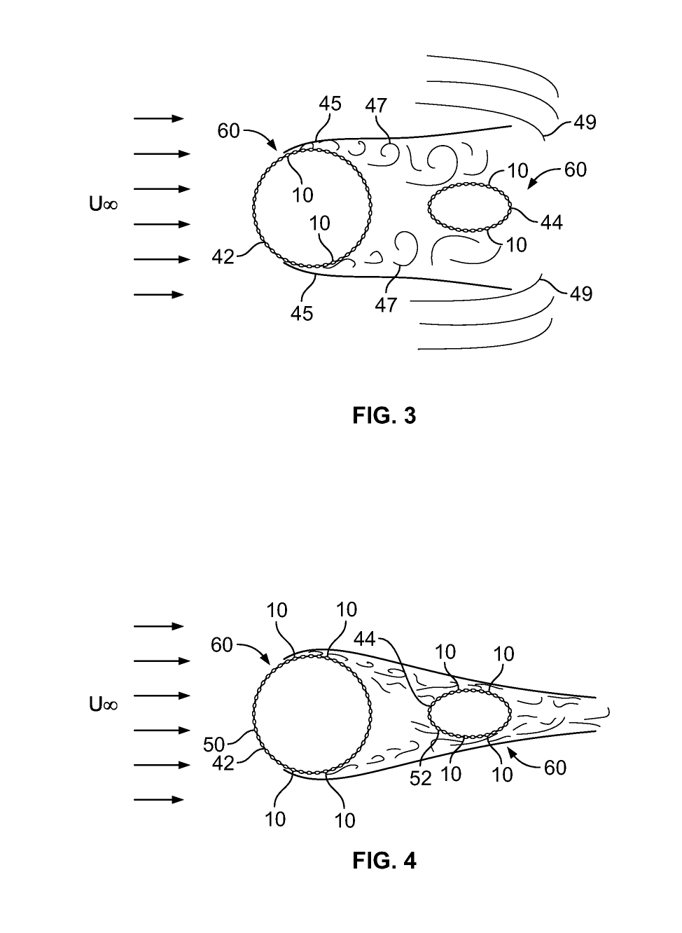

One example of the plasma fairing 60 is shown in FIG. 3 where the generic landing gear 40 is shown in cross-section taken along line 3-3 of FIG. 2. In this example, a plurality of plasma actuators 10 are mounted on the outer surface of both the upstream strut 42 and the downstream strut 44. Additionally, both the upstream strut 42 and the downstream strut 44 are subject to a free stream velocity U_{∞}. While the free stream velocity U_{∞} is illustrated as being generally parallel to the plane of the upstream strut 42 and the downstream strut 44, the free stream velocity U_{∞} may be from any direction. In the example of FIG. 3, a schematic of the typical flow of the free stream velocity U_{∞} without any of the actuators 10 being energized is shown. In this example, the resulting flow is characterized by large-scale separation 45 over the leading and training elements of the upstream strut 42, and the formation of unsteady large-scale vorticity 47 in the wake that is subsequently distorted by the downstream strut 44. This interaction gives rise to an effective dipole source for acoustic radiation 49.

FIG. 4 illustrates a plurality of SDBD plasma actuators 10 mounted on an outer surface 50 of the upstream strut 42 and on an outer surface 52 of the downstream strut 44 to form the plasma fairing 60. In the illustrated example, an array of SDBD plasma actuators 10 substantially covers at least a portion of the outer surfaces 50, 52 of the struts 42, 44. It will be understood, however, that the actuators 10 may be strategically placed anywhere along the outer surfaces 50, 52, and may include as few as a single actuator. Furthermore, while not shown in cross section, the actuators 10 may extend along the length of the struts 42, 44, to provide greater coverage of the surfaces 50, 52 (see FIG. 2).

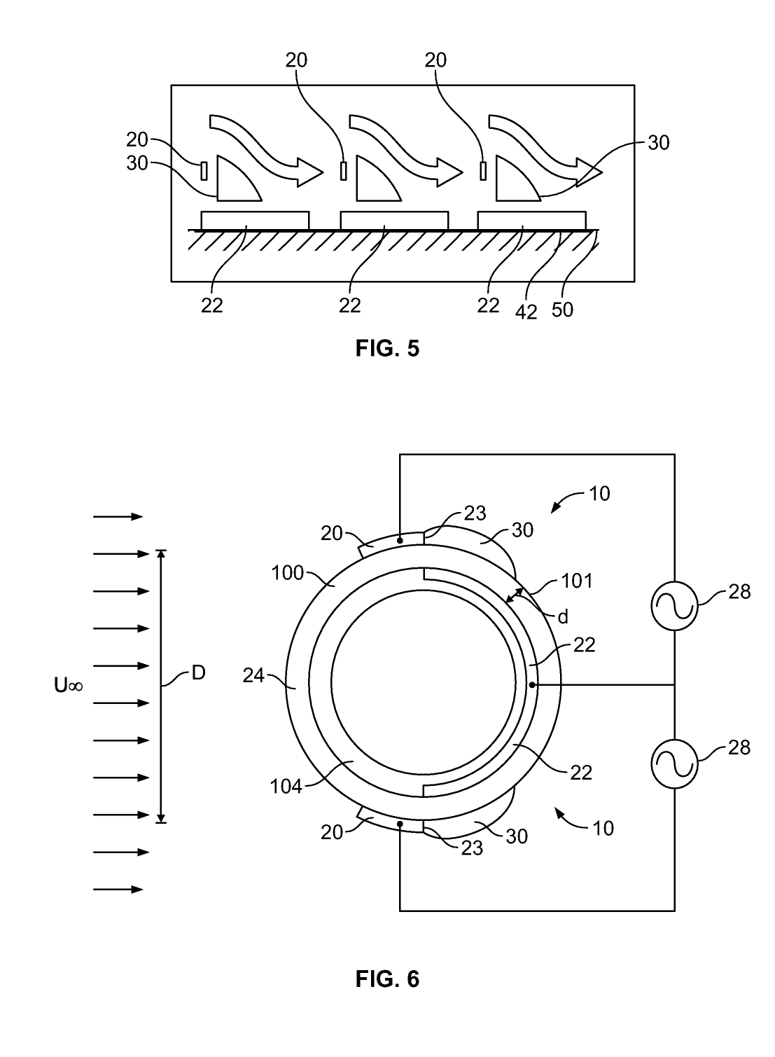

In operation, the plasma fairing 60 is subjected to the free stream velocity U_{∞}, but with the actuators 40 energized by the power supply 28. In the example shown in FIG. 4, the electrodes 20, 22 are energized so as to transport high momentum fluid toward the surface away from the struts 42, 44, giving rise to a local wall jet effect (see FIG. 5). This serves to re-energize the near-wall boundary layer and drastically delays separation. In this manner the plasma actuators 10 give rise to a fairing effect. In addition, modification of bluff body base flow by application of base suction renders the flow more absolutely unstable but decreases the spatial extent of the region of absolute instability. This has a net favorable effect on reducing global modes which are responsible for vortex shedding. Plasma actuators 10 operated on the back side of the struts 42, 44 may also be used to duplicate the effects of base bleed or suction and thereby reduce the shedding that comes about as a consequence of global instability modes.

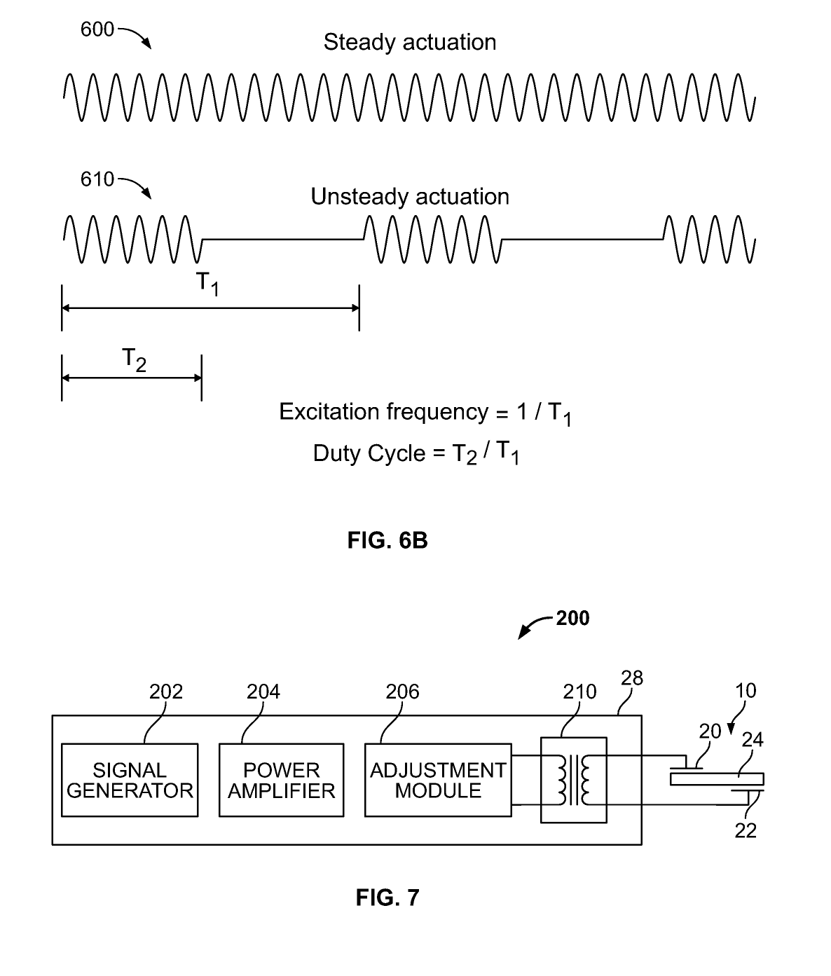

In order to demonstrate the fairing effect, consideration is given to the application of twin SDBD plasma actuators 10 for the control of separation from a cylinder 100 in cross-flow as illustrated in FIG. 6. The cylinder 100 is similar in its essential aspects to the landing gear struts 42, 44 shown in FIG. 2. In particular, in the illustration of FIG. 6, twin plasma actuators 10 are mounted on an outer surface 101 of the cylinder 100. In this example, the cylinder 100 is a quartz glass tube with an outer diameter D=36 mm, a wall thickness d=3 mm, and dielectric constant of 3.7. Also, in this example, the cylinder 100 wall serves as the dielectric barrier 24 for the SDBD plasma actuator 10. It will be appreciated, however, the SDBD plasma actuators 10 could be separately formed (as in FIG. 1) and mounted, and/or otherwise coupled, to the outer surface 101 of the cylinder 100 such that the cylinder 100 act as the substrate 26.

The outer, exposed electrodes 20 are mounted to the top and bottom of the cylinder 100 with plasma generating edges 23 being at approximately perpendicular to the flow direction F. In this example, the electrodes 20 are made of 1.6 mil thick copper foil of width 12.7 mm. The inner electrode 22 is common to both actuators 10 and is also made of 1.6 mil thick copper foil but its width is 50.8 mm (note that the thickness of the electrodes 20, 22 is greatly exaggerated in FIG. 6). The inner electrode 22 is mounted to an inner surface 102 of the cylinder 100. Both the inner electrodes 20 and the outer electrode 22 extend 0.508 meters in the spanwise direction. To prevent inner discharge, an insulation layer 104, such as, for example, ten layers of 5-mil-thick insulative tape, such as KAPTON® polymide film, marketed by E. I. du Pont de Nemours and Company, Wilmington, Del., cover the inner electrode 22. The outer electrodes 20 and the inner electrode 22 have a small overlap which gives rise to a large local electric field gradient. In operation, the plasma 30 forms near the edge 23 of the exposed electrode 20 and extends a distance along the cylinder's dielectric surface 100.

As illustrated in FIG. 6, the actuators 10 are electrically coupled to the AC source 28 that, in this example, provides 8.1 kV rms sinusoidal excitation (11.4 kV amplitude) to the electrodes at a frequency of 10 kHz. This frequency is considerably higher than any relevant time scales associated with the free stream velocity U_{∞}. Hence the body force on the ambient fluid may be considered effectively constant and the resulting actuation steady.

The example SDBD plasma actuator 10 utilizes an AC voltage power supply 28 for its sustenance. However, if the time scale associated with the AC signal driving the formation of the plasma 30 is sufficiently small in relation to any relevant time scales for the flow, the associated body force produced by the plasma 30 may be considered effectively steady. However, unsteady actuation may also be applied and in certain circumstances may pose distinct advantages. Signals for steady versus unsteady actuation are contrasted in FIG. 6B. In the illustrated example, an example steady actuation signal 600 in comparison with an unsteady actuation signal 610. Both the steady actuation signal 600 and the unsteady actuation signal 610 utilize the same high frequency sinusoid. Referring to the figure, it is apparent that with regard to the unsteady actuation signal 610, during time interval T₁ the plasma actuator 10 is on only during the sub-interval T₂. Hence, the signal sent to the actuator 10 has a characteristic frequency of f=1/T₁ that will be much lower than that of the sinusoid and will comparable to some relevant frequency of the particular flow that one wishes to control. In addition, an associated duty cycle T₂/T₁ may be defined. It will be understood that the frequency and duty cycle may be independently controlled for a given flow control application as desired.

FIG. 7 shows a sample circuit 200 used to create the high-frequency, high-amplitude AC voltage generated by the AC source 28. In this example, a low amplitude, sinusoidal waveform signal is generated by a signal generator 202, such as a Stanford Research Systems DS335. The generated signal is supplied to a power amplifier 204, such as a two-channel Crown CE4000. The amplified voltage is then fed trough an adjustment module 206 into the primary coil of a 1:180 transformer 210, such as a Corona Magnetics transformer, to increase the voltage level to 8.1 kV rms. The adjustment module 206 includes resistors which limit the current through the primary coil and capacitors to adjust the resonant frequency of the system. The high voltage output for the excitation of the plasma actuators 10 is obtained from the secondary coil of the transformer 210. One channel of the power amplifier 204 may be used to feed the plasma actuator 10 on the top of the cylinder, while the other channel may be used for the bottom plasma actuator 10 (only one channel is shown in FIG. 7). Similarly, the channels may be output as in-phase or out of phase as desired.

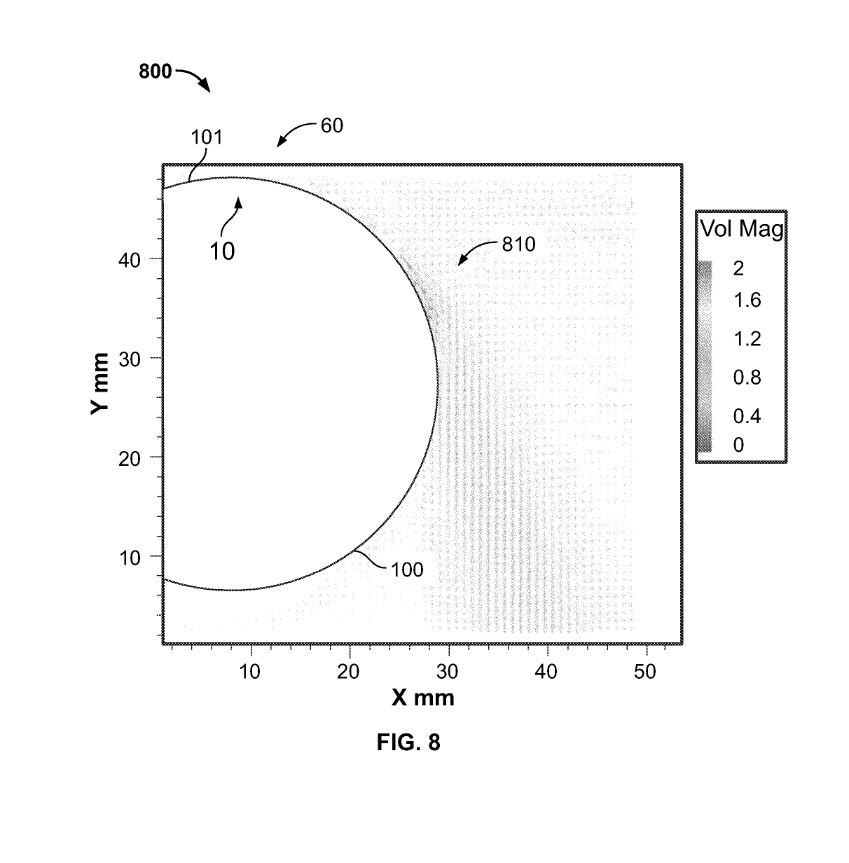

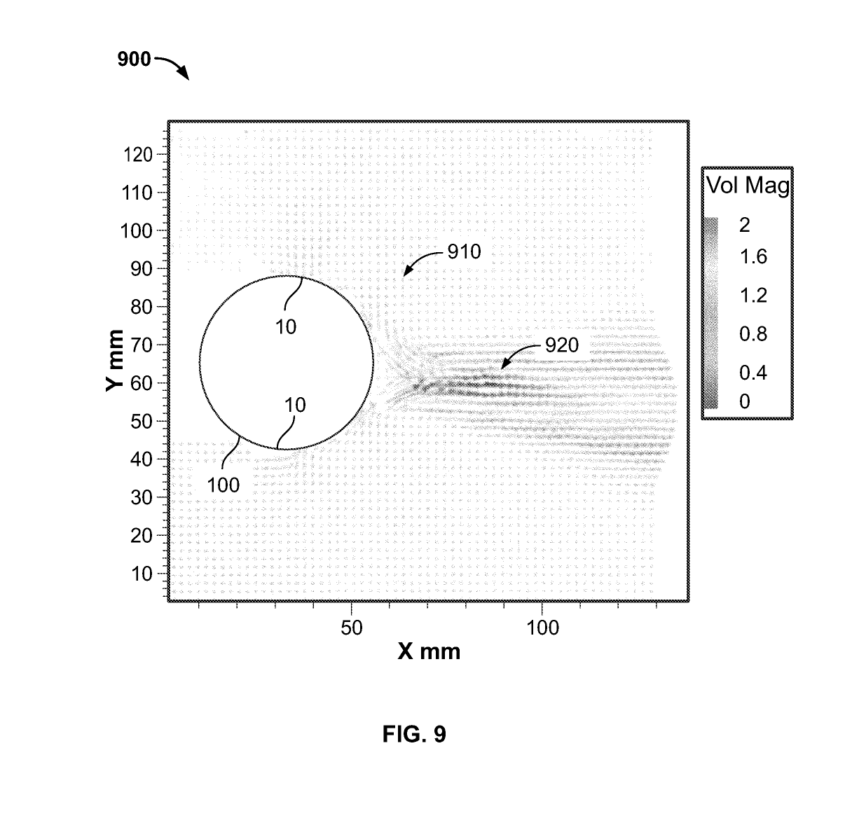

In one example, shown in FIGS. 8 and 9, the plasma fairing 60 is operated without being subjected to the free stream velocity U_{∞}. In particular, FIGS. 8 and 9 show the behavior of the faired flow induced solely by the twin plasma actuators 10 of FIG. 6. For example, the plasma fairing 60 shown in FIG. 6 was mounted in a box 1.2 m in length, 0.6 m width and 0.91 m in height in order to shield the plasma fairing 60 from ambient air flow within the laboratory. Three sides of the box were made of Plexiglas to allow optical access. The flow field generated by the twin SDBD plasma actuators 10 was measured non-intrusively by using a TSI particle image velocimetry (PIV) system. The air within the box was seeded with olive oil droplets of nominally 1 micrometer diameter. The droplets were generated by a TSI atomizer, such as, for example, a model Y120-15 New Wave Research Nd:Yag laser produced double pulses with a 50 μsec time interval. The pulse repetition rate was 15 Hz.

FIG. 8 illustrates a vector velocity field plot 800 of the flow field induced by the steady operation of the top actuator 10 only. This vector velocity field plot 800 represents an ensemble average over 100 sample images. This figure shows that the local tangential blowing 810 induced by the top actuator 10 adheres to the surface 101 of the cylinder 100 for a considerable distance via an apparent Coanda-like effect. That the plasma actuator 10 propels comparatively high momentum fluid along the cylinder surface 101 is beneficial in maintaining flow attachment and is one feature of plasma fairing.

FIG. 9 illustrates a vector velocity field plot 900 of the flow field due to the steady operation of both top and bottom plasma actuators 10. Each actuator 10 is observed to generate a flow 910 along the cylinder surface via a Coanda effect. These surface flows 910 meet and give rise to a jet of fluid 920 that propagates away from the cylinder 100. In both FIGS. 8 and 9, the highest mean velocities indicated are on the order of 2 m/s. However, this is limited by the resolution of the flow field images. In fact, PIV measurements made at higher spatial resolution near the actuators indicate that the highest mean velocities peak at approximately 10 m/s.

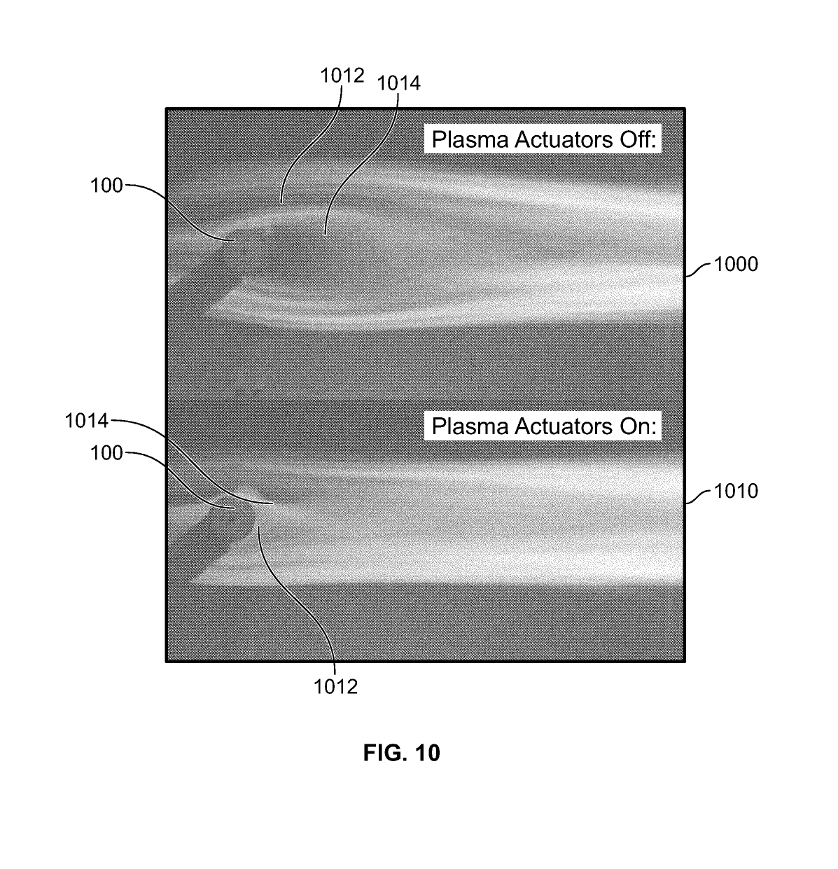

FIGS. 10 through 15 illustrate another example of operation performed in one of the low-turbulence, subsonic, in-draft wind tunnels located at the Hessert Laboratory for Aerospace Research at the University of Notre Dame utilized to generate the free stream velocity U_{∞}. The wind tunnel has an inlet with contraction ratio of 20:1. A series of 12 turbulence management screens at the front of the inlet give rise to tunnel freestream turbulence levels less than 0.1% (0.06% for frequencies above 10 Hz). Experiments were performed in two different test sections, both of 0.610 m square cross-section and 1.82 m in length. One had an optical access for non-intrusive laser flow field diagnostics (laser Doppler and stereo particle image velocimetry). To facilitate associated acoustic measurements, a second test section was utilized in which the top and bottom walls contain acoustically absorbent cavities.

As illustrated in FIGS. 10-15, in order to demonstrate bluff body flow control capabilities in a geometry relevant to the landing gear 40, the cylinder 100 shown in FIG. 6 was mounted in the in-draft wind tunnel and a preliminary series of flow control experiments were made. These involved smoke injection flow visualization, wake mean velocity profiles, drag measurements (based on integrated wake momentum defect), and vortex shedding measurements. All of these were performed both with and without plasma actuation. Throughout the experiments, the actuation level was kept fixed at the value previously noted and the Reynolds number of the flow varied. As such, these results provide an indication of the degree of streamlining achieved at fixed actuator amplitude as the free stream velocity U_{∞} varied.

Turning to FIG. 10, an example of the influence of the plasma actuators 10 on the global structure of the flow compares smoke flow visualization images of the cylinder wake with the actuators 10 on (1000) and off (1010). With the actuators 10 off (1000), the flow undergoes subcritical separation leading to a large-scale separated flow region (1012) that is accompanied by unsteady large-scale vortex shedding (1014). With the actuators 10 turned on (1010), the plasma actuators 10 substantially reduce the extent of the separated flow region (1012) and the associated shedding (1014). That the flow remains attached over a much larger extent of the cylinder surface is likely associated with the Coanda effect shown in FIGS. 8 and 9, which would serve to channel comparatively high momentum fluid to the near-wall region with a consequent favorable effect on maintaining flow attachment.

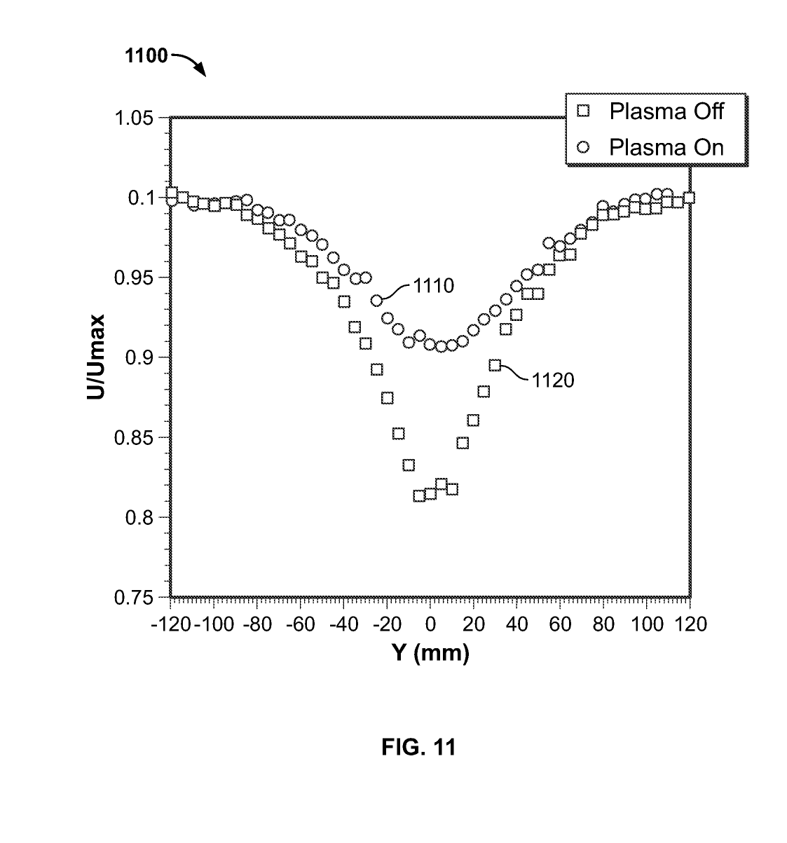

Cross-flow traverses of a Pitot-static probe over a representative range of streamwise locations downstream of the cylinder 100 were used to obtain wake mean velocity profiles with and without actuation. As an example, FIG. 11 is a graph (1100) comparing the wake mean velocity profiles with (1110) and without (1120) energizing the plasma actuators 10 as obtained 10 diameters downstream of the cylinder at a Reynolds number of ReD=18,000. FIG. 11 shows the significant effect the two surface-mounted plasma actuators 10 have in modifying the wake mean velocity profile, such as, for example, the reduction in the velocity defect.

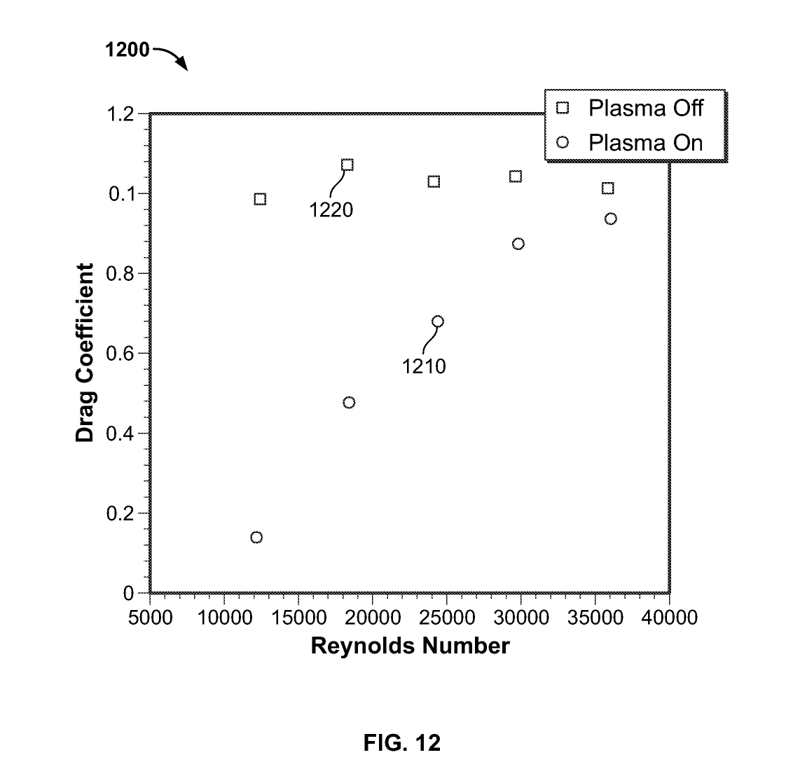

FIG. 12 is a graph (1200) of the measured drag coefficient of the cylinder 100, both with (1210) and without (1220) energizing of the plasma actuators 10, as a function of the Reynolds number ReD. These drag measurements were obtained by integration of cross-stream mean velocity profiles like those shown previously in FIG. 11 along with application of appropriate tunnel blockage corrections. As expected for subcritical separation, with the plasma off (1220) the cylinder drag coefficient is just above 1.0 and is largely independent of Reynolds number. With the plasma on (1210), drag reduction of approximately 90% is noted at the lowest Reynolds numbers tested. The reduction in drag decreases in a continuous manner with Reynolds number which suggests that the degree of effective streamlining depends on the magnitude of actuator-induced perturbation in relation to the free stream velocity U_{∞}. Recall that the plasma actuation amplitude has been kept fixed as the approach velocity was varied.

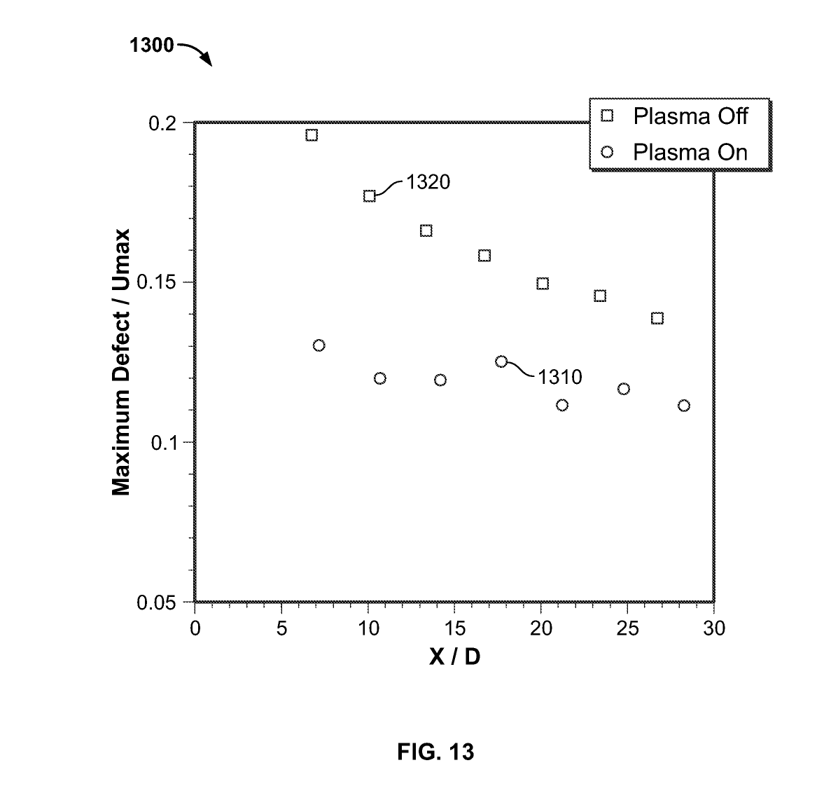

FIG. 13 is a graph (1300) comparing the streamwise variation in wake maximum velocity defect (normalized by the external freestream velocity) with the plasma actuators 10 on (1310) and off (1320). This data was acquired at a Reynolds number of ReD=24,000. Consistent with FIGS. 11 and 12, the maximum velocity defect is reduced considerably with the plasma actuators 10 on (1310) than with the plasma actuators 10 off (1320). Note however, that the influence of the plasma actuators 10 is substantially global. That is, it is not localized to the near wake region but extends to larger values of x/D, which is consistent with the idea that the actuators 10 have effectively streamlined the cylinder 100. Also apparent from FIG. 13 is that the velocity defect decay rate is reduced with the plasma on (1310).

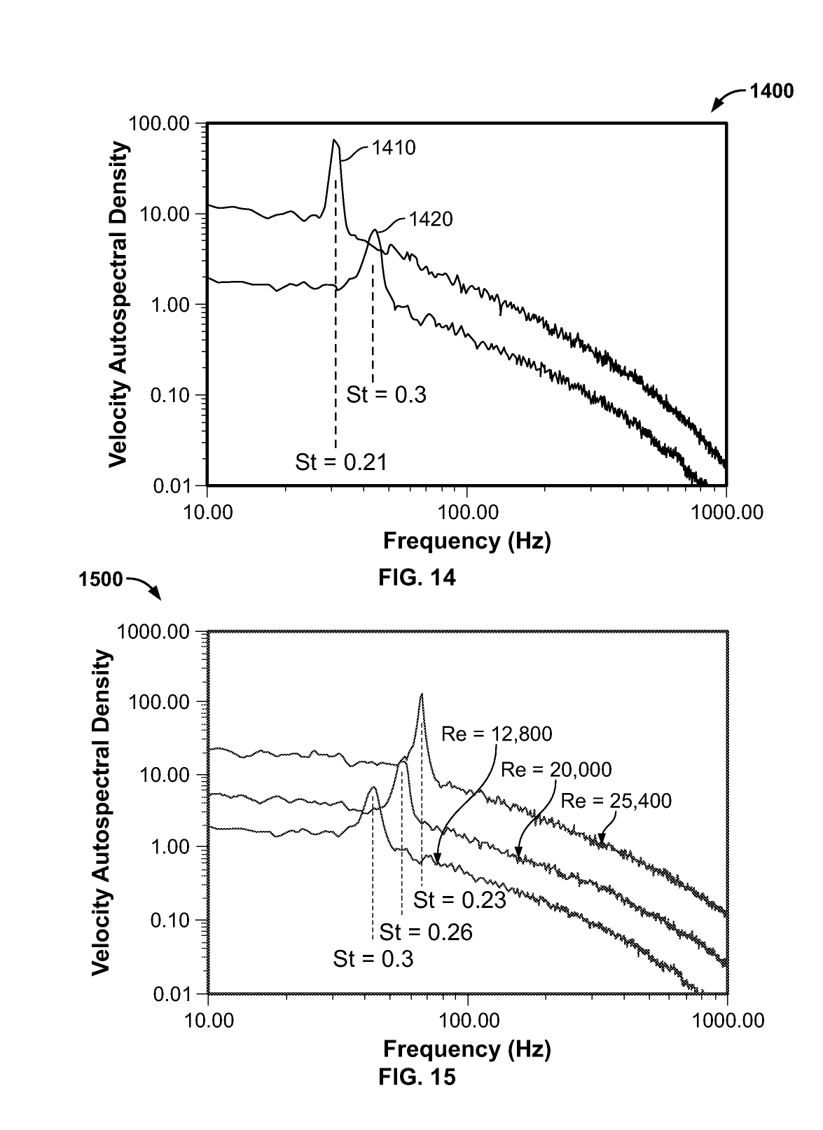

In order to investigate the effect of the plasma actuators 10 on the unsteady vortex shedding characteristics, constant temperature hot-wire anemometry was used to acquire instantaneous streamwise velocity component time-series data. The data was acquired at a sample frequency of 10 kHz, with an anti-alias filter cutoff of 1 kHz. Standard Fast Fourier Transform (FFT) techniques were used to compute the corresponding autospectral density functions. A blocksize of 8192 points was used for the FFT and the spectra were ensemble averaged over 128 blocks (a number sufficient to provide smooth, fully converged spectral estimates). A graph (1400) of an example velocity spectra obtained for ReD=12,800 is shown in FIG. 14. Velocity autospectra obtained with the plasma actuators 10 off (1410) are generally broadband except for a discrete spectral peak centered at a Strouhal number StD=0.21 which is associated with vortex shedding from the separated flow region. With the plasma actuators 10 on (1420), the shedding frequency is shifted to a higher Strouhal number and the power contained at the shedding frequency is reduced by up to an order of magnitude. An example spectrum obtained with the plasma on is as also shown in FIG. 14. The increase in StD when the plasma actuators 10 is on is likely associated with a reduction in size of the separated region.

FIG. 15 is a graph 1500 illustrating the variation with ReD of a velocity autospectra obtained at fixed position x/D=10, y/D=2 with the plasma actuators 10 on. As the Reynolds number increases, the Strouhal number associated with shedding gradually decreases and the power contained at the shedding frequency increases. Recall that the plasma actuator 10 amplitude has been kept constant in each case. Both the decrease in StD associated with shedding and the increase in spectral content at the shedding frequency is consistent with growth in the size of the separated flow region as ReD increases. This, in turn, is consistent with the variation in drag coefficient with ReD as shown in FIG. 12.

The results presented from the preliminary plasma flow control demonstrate that the SDBD plasma actuators 10 provide effective streamlining of bluff body landing gear elements. It is important to recall that unlike the actuator array on the landing gear element depicted in FIG. 4, the examples illustrated above utilize only two plasma actuators 10 such as depicted in FIG. 6. Despite this, reductions in both drag and vortex shedding have been demonstrated. With additional actuators 10 placed on the cylinder 100, the unsteady vortex shedding may be substantially eliminated.

In the application of the plasma actuators 10 to landing gear separation control, it is noted that the optimum actuation strategy for noise reduction will vary based upon the landing gear design. For example, the examples presented thus far has focused on using SDBD plasma actuators 10 to create blowing that is locally tangential to the support surface 26 for the purpose of eliminating or delaying boundary layer separation and associated bluff body vortex shedding. However, it will be appreciated by one of ordinary skill in the art that alternate actuation strategies may also be utilized for landing gear noise reduction.

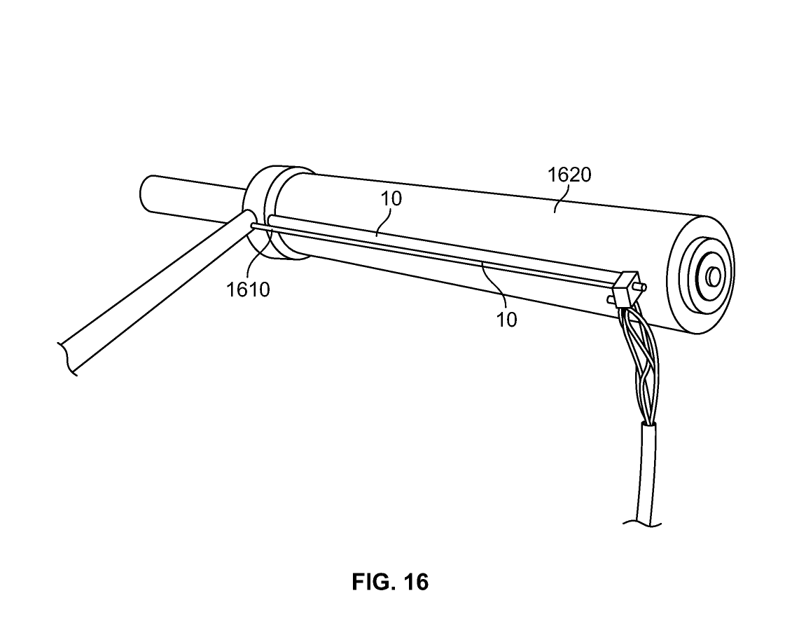

For example, as described earlier, modification of bluff body base flow by application of base suction renders the flow more absolutely unstable (which is undesirable) but decreases the spatial extent of the region of absolute instability (which is desirable). This has a net favorable effect on reducing global modes which are responsible for vortex shedding. In contrast, it has also been noted that base bleed renders the flow less absolutely unstable. This suggests that plasma actuators 10 operated on the back side of a landing gear struts 42, 44 may be used to duplicate the effects of base bleed or suction and thereby reduce the shedding that comes about as a consequence of global instability modes. This example is illustrated in FIG. 16.

In particular, in an effort to alter the global instability, plasma actuators 10 are used to create base blowing. In order to accomplish this, a short splitter plate 1610 may be attached to the downstream side of a model landing gear 1620 similar to the cylinder 100. Additionally, at least one SDBD plasma actuator 10 may be mounted on each side of the splitter plate 1610. The arrangement of the electrodes 10 may give rise to tangential blowing away from the landing gear 1620 (i.e. base blowing). In this example, the electrodes of the actuators 10 extend in the spanwise direction for the length of the landing gear element 1610. In order to characterize the velocity perturbation produced by the actuators, the landing gear model 1620 was mounted in the same box used for the images in FIGS. 8 and 9, and non-intrusive PIV measurements of the actuator-induced flow were made.

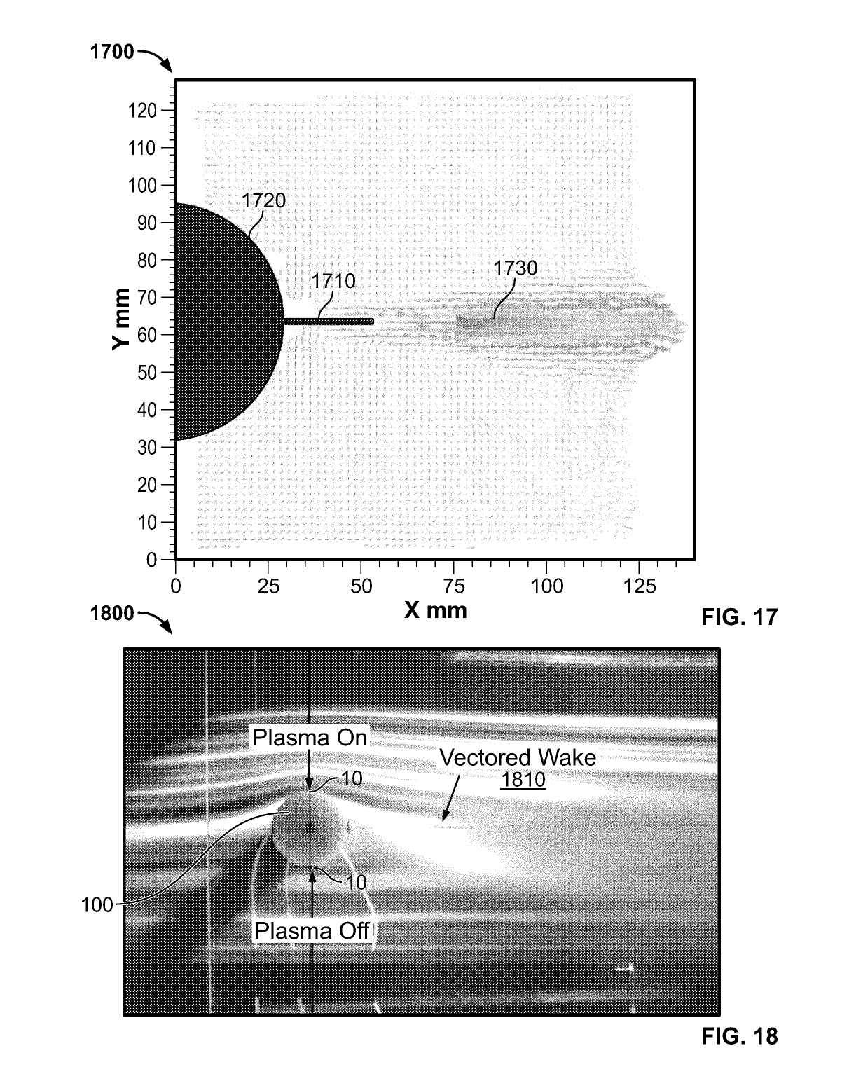

A representative graph 1700 is shown in FIG. 17 and illustrates the ensemble-averaged velocity field produced by the actuators 10. This figure clearly shows the plasma-induced jet directed away from the landing gear strut 1720 and confirms the ability to use the plasma actuators 10 to create a base blowing effect. One of the advantages of the plasma actuator 10 is that this blowing is accomplished without the necessity for complex bleed air ducting systems as described above.

In yet another example, it is understood that the unsteady, large-scale vorticity in a wake that is subsequently distorted by a downstream gear element acts a source of acoustic emission. While the above referenced examples minimize or substantially eliminate unsteady bluff body shedding from gear components, an alternate and/or complementary strategy is to vector the wake from upstream gear elements away from downstream components and thereby minimize the distortion of shed vorticity, as illustrated in FIG. 18. To vector a wake 1810, the surface mounted plasma actuators 10 may be operated in an azimuthally asymmetric manner and the resulting Coanda effect exploited to effectively steer the wake away from downstream elements. As illustrated in FIG. 18, a smoke flow visualization image 1800 of the cylinder model 100 in the wind tunnel with only the top plasma actuator 10 operating is shown. The wake 1810 from the cylinder 100 is clearly deflected downward in response to the asymmetric plasma actuation. As will be understood by one of ordinary skill in the art, additional actuators 10 may be placed upon the cylinder 100, or landing gear struts 42, 44, to better guide the wake 1810 in the azimuthal direction as desired.

While the illustrated example utilizes a cylinder 100, the SDBD plasma actuators 10 may be utilizing in any suitable airframe environment. Consider, for example, a Boeing 767-300 on landing approach at approximately 240 km/hour. The Reynolds number associated with flow over the landing gear oleo will be O(2×10⁶). This Reynolds number is considerably larger than that characterizing the reported flow control experiments utilizing the cylinder 100. In addition, the above illustrated results demonstrate that for fixed actuator amplitude, the effectiveness of the plasma actuators 10 in controlling bluff body separation diminishes with increased free stream velocity U_{∞} (e.g., approximately as U_{∞}^{-3.1}).

As previously noted, however, the actuation strategy utilized in the above referenced examples only utilized two actuators 10 in steady blowing. Accordingly, it may be apparent that the SDBD plasma actuator 10 landing gear flow control may require a greater body force per unit volume acting on the ambient air to be effectively scale to Reynolds numbers associated with commercial transport aircraft. For example, if one conservatively asserts, based on the experiments, that velocity perturbations O(U_{∞}/4) must be produced to insure bluff body flow attachment, this would require plasma-induced velocities of approximately 20 m/s for the Boeing 767-300. This in turn requires the generation of greater body force per unit volume. It has been shown that the body force vector is given by equation 1.

$${\vec{f}}_{b}^{*} = {ρ}_{c} \vec{E} = - ( \frac{{ɛ}_{o}}{{λ}_{D}^{2}} ) φ \vec{E} \qquad equation 1$$

In equation 1, \vec{f}*_{b} is the body force (per unit volume); ρ_{c} is the charge density; \vec{E} is the electric field vector; ∈_{O} is the electrical permittivity of free space; λ_{D} is the Debye length; and φ is the electric potential.

The body force vectors \vec{f}*_{b} may be tailored through the design of the electrode geometry and dielectric material that control the spatial electric field. For example, the electrode arrangement used in the above examples were designed to provide locally tangential blowing. It will be appreciated, however, the body force per unit volume \vec{f}*_{b} produced by the SDBD plasma actuators 10 may be increased by other means as desired.

For instance, in one example, the induced air velocity produced by a SDBD plasma actuator 10 with an electrode arrangement similar to that employed in the above examples varies with the applied AC voltage to the 7/2 power. Accordingly, modest applied voltage gains may produce significant increases in the magnitude of the velocity perturbations used for flow control. Because many of the flow-control effects scale as the free-stream speed to the −1 to −2 powers (e.g., −1.3), there may be an advantage to operating at higher voltages. Accordingly, by varying the selected material for the construction of the SDBD plasma actuator 10, one of ordinary skill in the art may safely increase the applied AC voltage.

In another example, it is known that the induced velocity by multiple actuators 10 arranged in series add linearly. In this manner, an array of actuators 10 similar to that shown in FIG. 5 may be utilized to promote greater flow attachment to the surface of the body. The use of multiple actuators 10 in series is typically limited only by a packing constraint set by the required size of the embedded electrodes.

In yet another example, many of the current designs of the SDBD plasma actuator have utilized a polyimide (KAPTON®) or Macor ceramic for the dielectric layer. Based on an equivalent circuit model of the SDBD actuator (not presented here), improvements in the dielectric strength (dielectric breakdown voltage) and dielectric constant of the barrier layer may significantly enhance the performance of the actuator 10.

Still further, numerous flow control studies have shown that unsteady plasma actuation offers significant performance gains over steady blowing, such as, for example, low-pressure turbine blade flow control, and airfoil separation control. For separation control it has been shown that actuation at a Strouhal number of 1 based on the characteristic length of the separated region is optimum. Unsteady actuation has the added benefit of reducing the power required for actuation because the duty cycle is significantly reduced.

Although the teachings of the invention have been illustrated in connection with certain embodiments, there is no intent to limit the invention to such embodiments. On the contrary, the intention of this application is to cover all modifications and embodiments fairly falling within the scope of the appended claims either literally or under the doctrine of equivalents.

We claim:

1. A plasma fairing comprising:
at least one plasma generating device coupled to an aircraft landing gear;
a power supply electrically coupled to the at least one plasma generating device such that when the power supply energizes the at least one plasma generating device, body flow separation of a fluid flow over the aircraft landing gear is reduced.

2. A plasma fairing as defined in claim 1, wherein the at least one plasma generating device is a single dielectric barrier discharge plasma actuator.

3. A plasma fairing as defined in claim 1, wherein the at least one plasma generating device is mounted substantially perpendicular to the direction of the fluid flow.

4. A plasma fairing as defined in claim 1, wherein the power supply is a high voltage AC current device.

5. A plasma fairing as defined in claim 1, wherein the aircraft landing gear includes an upstream element and a downstream element wherein the at least one plasma generating device is coupled to at least one of the upstream element or the downstream element.

6. A plasma fairing as defined in claim 5, wherein the at least one plasma generating device vectors the wake of the fluid flow over the upstream element away from the downstream element.

7. A plasma fairing as defined in claim 1, further comprising at least one array of plasma generating devices coupled to at least a portion of the outer surface of the aircraft landing gear.

8. A plasma fairing as defined in claim 1, wherein the power supply generates an unsteady actuation signal.

9. A method of attenuating noise generated by a body comprising:
coupling at least one plasma generating device to an outer surface of a body; and
energizing the at least one plasma generating device to produce a plasma when the body is subjected to a fluid flow.

10. A method as defined in claim 9, wherein the at least one plasma generating device is a single dielectric barrier discharge plasma actuator.

11. A method as defined in claim 9, wherein the at least one plasma generating device is mounted substantially perpendicular to the direction of the fluid flow.

12. A method as defined in claim 9, wherein energizing the at least one plasma device comprises electrically coupling a high voltage AC current device to the at least one plasma generating device.

13. A method as defined in claim 12, wherein the high voltage AC current device comprises a plurality of channels, and wherein at least one of the channels is electrically coupled to at least a selected one of the at least one plasma device.

14. A method as defined in claim 13, wherein at least two of the plurality of channels are substantially in-phase.

15. A method as defined in claim 9, wherein the body includes an upstream element and a downstream element and further comprising coupling the at least one plasma generating device to at least one of the upstream element or the downstream element to reduce body flow separation when energized.

16. A method as defined in claim 9, wherein the at least one plasma generating device is adapted to generate a self-limiting plasma.

17. A method as defined in claim 9, wherein the body is a landing gear.

18. A method as defined in claim 9, wherein mounting at least one plasma generating device further comprises mounting a plurality of plasma generating devices to the outer surface of the body.

19. A method as defined in claim 9, further comprising selectively energizing the at least one plasma generating device to selectively vector a wake of the fluid flow.

20. A method as defined in claim 19, wherein the body includes a leading element and a trailing element, and wherein selectively energizing the at least one plasma generating device vectors the wake of the fluid flow over the leading element away from the trailing element.

21. A method as defined in claim 9, further comprising coupling at least one array of plasma generating devices to at least a portion of the outer surface of the body.

22. A method as defined in claim 9, wherein energizing the at least one plasma generating device comprises generating an unsteady actuation signal and supplying the unsteady actuation signal to the plasma generating device.

23. An noise attenuating device comprising:
at least one plasma generating device mounted to an outer surface of a body; and
a power supply electrically coupled to the plasma generating device to cause the at least one plasma generating device to produce a plasma when the bluff body is subjected to a fluid flow.

24. A device as defined in claim 23, wherein the at least one plasma generating device is a single dielectric barrier discharge plasma actuator.

25. A device as defined in claim 23, wherein the body includes an upstream element and a downstream element wherein the at least one plasma generating device is coupled to at least one of the upstream element or the downstream element to reduce body flow separation when energized by the power supply.

26. A device as defined in claim 25, wherein the at least one plasma generating device vectors the wake of the fluid flow over the upstream element away from the downstream element.

27. A device as defined in claim 23, further comprising at least one array of plasma generating devices coupled to at least a portion of the outer surface of the body.
